(19) United States
(12) Patent Application Publication
(10) Pub. No.: US 2007/0083394 A1
(43) Pub. Date: Apr. 12, 2007

(54) Medical data collection for PDA

(76) Inventor: Narender Reddy, Orland Park, IL (US)

Correspondence Address: BEEM PATENT LAW FIRM, 53 W. JACKSON BLVD., SUITE 1352, CHICAGO, IL, 60604-3787, US

(21) Appl. No.: 11/247,006

(22) Filed: Oct. 7, 2005

(51) Int. Cl. G06F 19/00; G06F 17/00

(52) U.S. Cl. 705/3; 715/780; 715/810

(57) ABSTRACT

A method for creating, storing and transferring electronic patient records and for more effectively managing patient accounts receivable and billing includes storing one or more medical forms; converting each of the forms to a sequence of simplified screen displays; downloading said sequence of screen displays to a computer; and entering information into each of the screen displays as a sequence of selections from one or more display menus comprising a portion of each screen display. A system for managing medical records and billing data includes a server for storing one or more medical forms, for converting each of the forms to a sequence of simplified screen displays and for downloading this sequence of simplified screen displays to a user's computer. A user's computer enters information into each of the displays as selections from one or more display menus comprising a part of each screen display and uploads information entered via the screens to the server. A selectively usable data transfer facility between the server and the user's computer facilitates the downloading and uploading.

### BACKGROUND OF THE INVENTION

1. Field of the Invention

The present invention is directed to a method and system for managing patient medical records and billing data, greatly simplifying the entering and organizing of data and generating forms and reports such as billing information.

2. Description of the Related Art

The process by which physicians and other health care providers record patient information and transfer information to their billing managers has remained largely a manual form-based process. After treating a patient, the health care provider typically uses an encounter form to indicate the diagnosis/diagnoses and the services rendered. The health care provider or office staff may later submit the form to those responsible for billing. Accordingly, the ability to accurately bill, and receive payment for services is dependent upon the reliability of this process to correctly identify the patient, the services provided, and the appropriately corresponding diagnosis/diagnoses.

Physicians and other health care service providers are typically paid for their services by third party payers (such as private insurance carriers or government programs such as the Medicare and/or Medicaid programs), and must comply with the reporting requirements imposed by the third party(ies). Errors or noncompliance with these reporting requirements can result in a denial of or delay in payment for services.

More recently common diagnostic and service codes have been developed to simplify or standardize, at least in part, these requirements. These codes have been developed primarily by the Health Care Financing Administration (HCFA) of the U.S. government, and the American Medical Association (AMA). The HCFA codes are known as the health care procedure coding system (HCPCS). The HCPCS codes include AMA codes referred to as Current Procedural Terminology (CPT®). The CPT® codes are set out manuals which are updated from time to time. The codes selected by HCFA are referred to as the International Classification of Diseases (ICD). Like the CPT® codes, the ICD codes are set out manuals and are also subject to periodic revision. The current ICD manual is currently the ninth revision, referred to as ICD-9 codes.

Accordingly, the billing office must include the proper codes on the claim form. Failure to provide the proper codes usually results in an initial denial of payment and a significant delay in the billing and collection process. Typically, errors in the codes result from inaccuracies in creating the claim from the information submitted by the provider somewhere along the chain of persons or entities processing this information. For example, the information submitted by the provider is usually processed by the provider's or hospital staff, and then by the billing office, which may be an outsourced function. Therefore, errors can and do occur as the information is processed by different entities using different systems.

With the foregoing system, charges are often either not submitted at all, submitted incompletely, or submitted after long delays, resulting in significant losses.

### BRIEF SUMMARY OF THE INVENTION

It is an object of the invention to provide a method and system for managing patient medical records and billing data, while avoiding difficulties in entering and organizing data and generating forms and reports such as billing information.

In accordance with one aspect of the invention, a system for managing medical records and billing data comprises means for storing one or more medical forms; means for converting each of said forms to a sequence of simplified screen displays; means for downloading said sequence of simplified screen displays to a computer, and means for entering information into each of said displays as selections from one or more display menus comprising a part of said screen displays.

In accordance with another aspect of the invention, a method for managing medical records and billing data comprises storing one or more medical forms; converting each of said forms to a sequence of simplified screen displays; downloading said sequence of screen displays to a computer, and entering information into each of said screen displays as a sequence of selections from one or more display menus comprising a portion of said screen displays.

In accordance with another aspect of the invention, a system for managing medical records and billing data comprises a server for storing one or more medical forms, for converting each of said forms to a sequence of simplified screen displays and for downloading said sequence of simplified screen displays to a user's computer; a user's computer for entering information into each of said displays as selections from one or more display menus comprising a part of said screen displays and for uploading information entered via said screens to another computer, and a selectively usable connecting facility between said server and said user's computer for facilitating said downloading and said uploading.

These and other features and advantages are evident from the following description of the present invention, with reference to the accompanying drawings.

### BRIEF DESCRIPTION OF THE DRAWINGS

FIG. 1 shows a User Login screen;

FIG. 2 shows a Patient List screen;

FIG. 3 shows a Patient Search screen;

FIG. 4 shows a New Patient screen;

FIG. 5 shows a Patient Summary screen;

FIG. 6 shows a Patient Detail screen and Patient Summary Option menu;

FIG. 7 shows a Forms menu option;

FIG. 8 shows a Form Level Summary screen;

FIG. 9 shows a Form menu selection;

FIG. 10 shows a CPT® coding selections;

FIG. 11 shows a sample CPT® coding screen;

FIG. 12 shows a sample Victim Type screen;

FIG. 13 shows a sample Diagnosis screen;

FIG. 14 shows a sample Other screen;

FIG. 15 shows a History screen for H&P 1;

FIG. 16 shows a Procedure Screen for H&P 1;

FIG. 17 shows an Additional Information text area for H&P 1;

FIG. 18 shows a History screen for H&P 2;

FIG. 19 shows a Vital Signs screen for H&P 2;

FIG. 20 shows a Diagnosis 1 screen for H&P 2;

FIG. 21 shows a Diagnosis 2 screen for H&P 2;

FIG. 22 shows a Diagnosis 3 screen for H&P 2;

FIG. 23 shows a Lab Results screen for H&P 2;

FIG. 24 shows an Encounter Inpatient Diagnosis screen;

FIG. 25 shows a sample Summary with Diagnosis Information;

FIG. 26 shows a Trauma Activation Summary screen;

FIG. 27 shows a sample Trauma Activation Detail screen;

FIG. 28 shows an H&P 1—head shots screen;

FIG. 29 shows an H&P 2—faceup screen;

FIG. 30 shows an H&P 2—facedown screen;

FIG. 31 shows a screen with Comment Section colorings;

FIG. 32 shows a Comment window;

FIG. 33 shows a Date Menu selection;

FIG. 34 shows a Date/Time window;

FIG. 35 shows a System Diagram screen;

FIG. 36 shows a screen flow diagram;

FIG. 37 shows a User Select screen, and

FIG. 38 shows a User ID and Password Maintenance screen.

### DETAILED DESCRIPTION

The described embodiment of the invention comprises a method and system for creating, storing and transferring electronic patient records and for more effectively managing patient accounts receivable and billing. The system includes a user interface and application for collection or retrieval of patient data, using a portable device, and an interface to other databases/servers, i.e. billing records system. The described embodiment of the invention provides physicians or other heath care providers with a handheld or other portable device with a user interface application with forms and prompts for recording patient data, then to interface for uploading and downloading data with networked PCs or servers. The use of a portable device, with fast access to data and ease of data entry, is particularly useful in trauma centers, which application is described in detail below. However, the invention is not limited to this application.

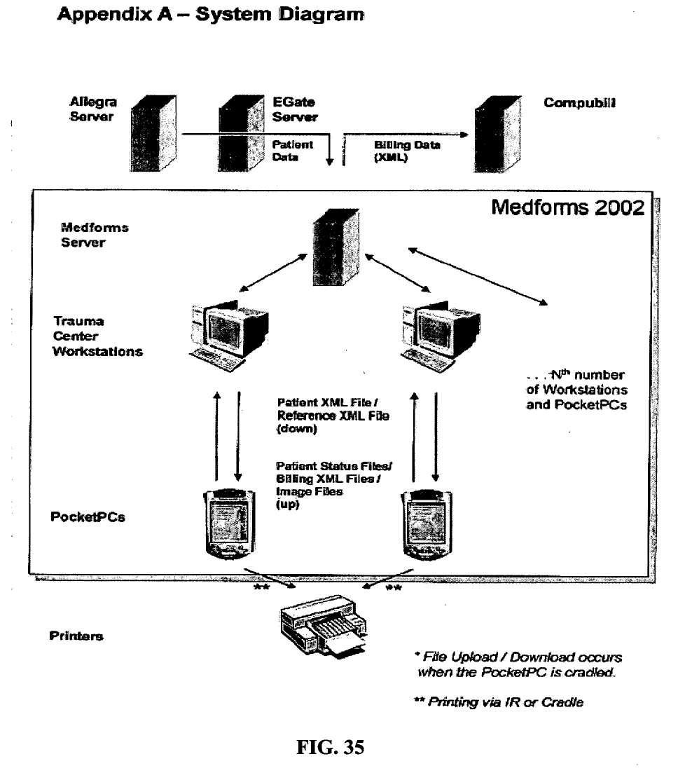

Referring initially to FIG. 35, a software application in accordance with the invention, which we have termed a Medforms application, the essential features of which are described herein, may be installed on a hand held unit 40 such as a Compaq iPAQ PocketPC or similar unit along with the NSICom CrEme™ Java Virtual Machine, Field Software Printer CE, and Synchrologic File Sync. The PocketPC 40 may have a minimum of 32 MB of memory and be a 3800 series or later. The user may have access to a networked workstation 50 with a cradle (not shown) and the appropriate related software installed for synchronizing information between the PocketPC 40 and the Medforms server 60. A laptop computer could also be used in place of the hand held unit. As will be seen, the invention is specially adapted to use of a hand held unit or PDA; however, it may also be used on other devices, such as laptops, PCs, etc.

In essence, the Medforms server 60 stores one or more medical forms, converts each of the forms to a sequence of simplified screen displays and downloads the sequence of simplified screen displays to a user's computer, such as the handheld unit 40. The user's computer enters information into each of the screen displays by selecting items from one or more display menus presented by the screen displays and for uploading information entered via said screens to the server 60. The workstation 50 and cradle (not shown) or other docking or data interface device facilitate the downloading and uploading processes.

The Medforms application provides user interface forms on a portable device, such as a laptop or Personal Digital Assistant (PDA), including display of hospital Admissions/Discharge/Transfer (ADT) data downloaded from the hospital database, search for patient information, both summary and detailed, entry of patient encounter data and codes, viewing patient history data, entry of diagnosis and lab results, viewing image screens and drawing on images with a stylus, adding comments or additional information, printing forms (for partial or completed data entry) and interfaces to billing system to create billing records. This enhances the accuracy and speed of data entry and retrieval, at the point of care, without using manual forms or images, and synchronizing patient data and billing records with other database/systems.

Synchronizing Patient Admissions/Discharge/Transfer (ADT) Data

The first step to using the Medforms application is to cradle the PocketPC at the workstation. Note: Do not touch the keyboard or mouse for 5-10 seconds while the system recognizes the device, which may appear as a series of windows opening and closing automatically. Shortly after that process is finished, the workstation will automatically begin the synchronization process. This process may take up to 2-3 minutes to complete.

Using the Medforms Application

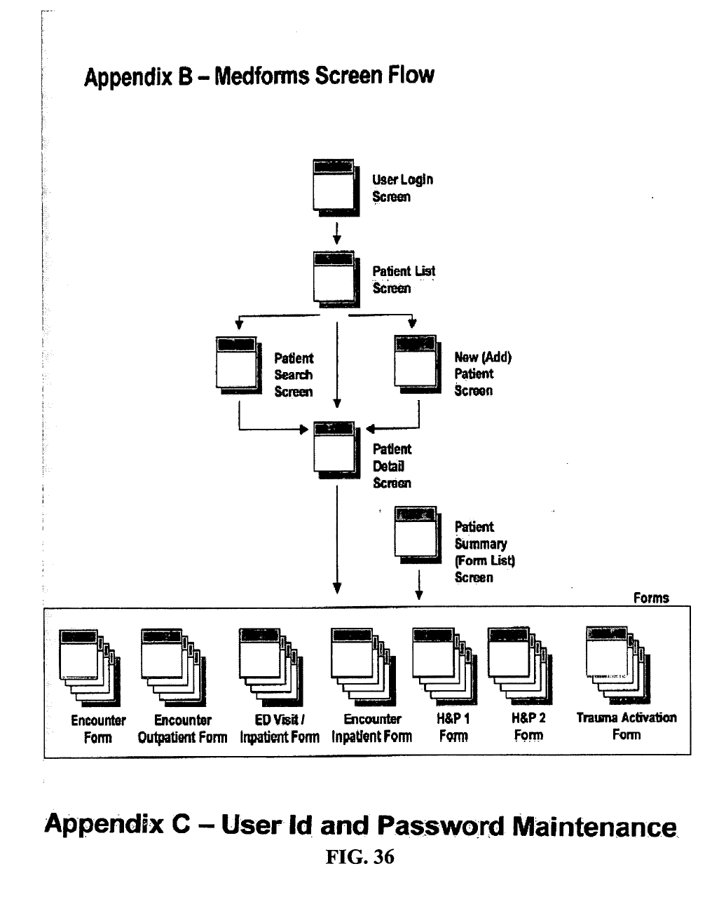

Once the synchronization process is complete, you may start the Medforms application. It may be run either in the cradle or out of the cradle. Tap the Start menu and select Medforms from the list of programs to run. It will take a few seconds while the new patient ADT records are loaded into the application and then you will see the User Login screen. See FIG. 1. You are now ready to login and use the Medforms application. User Id and Passwords are maintained on the Medforms server 60 (FIG. 35). The screen flow for the screens described below is shown in FIG. 36, to which reference is also invited.

Help

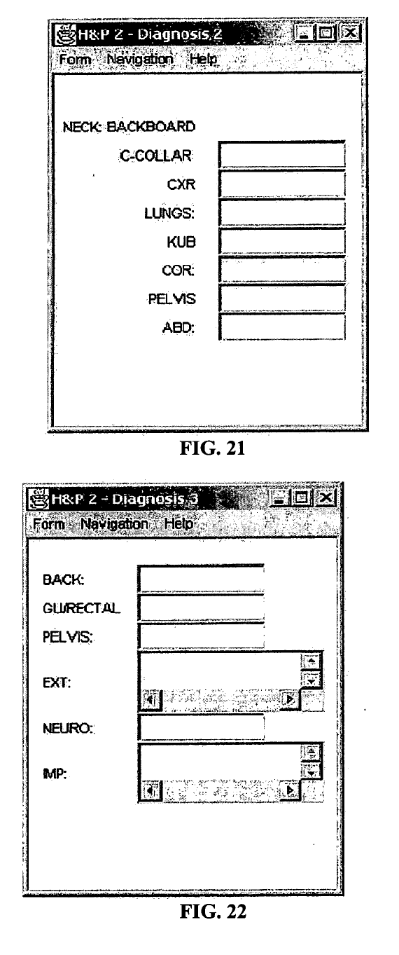

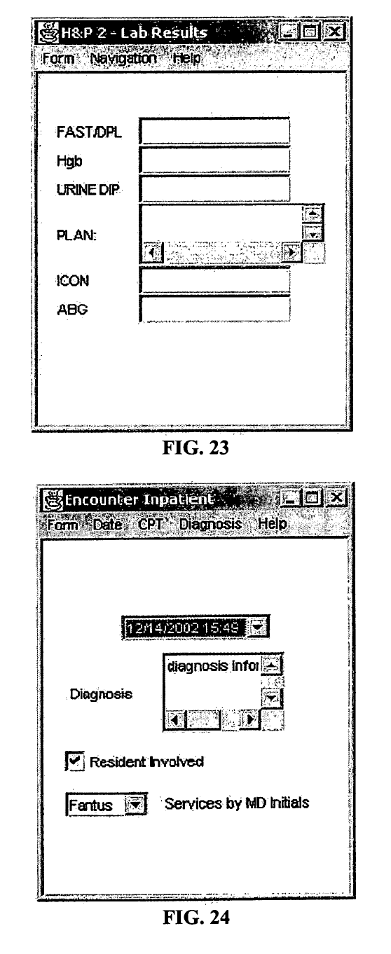

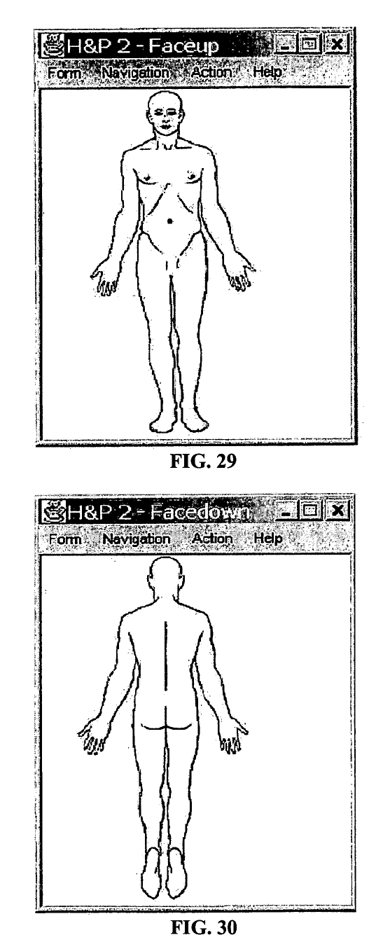

Context sensitive help is available from every screen (FIGS. 1-33) in the Medforms application. Simply tap on the ‘Help’ menu option from any screen inside the application. The help file will open in a new window. After reading the help documentation, close the help to return to the Medforms application.

Patient List

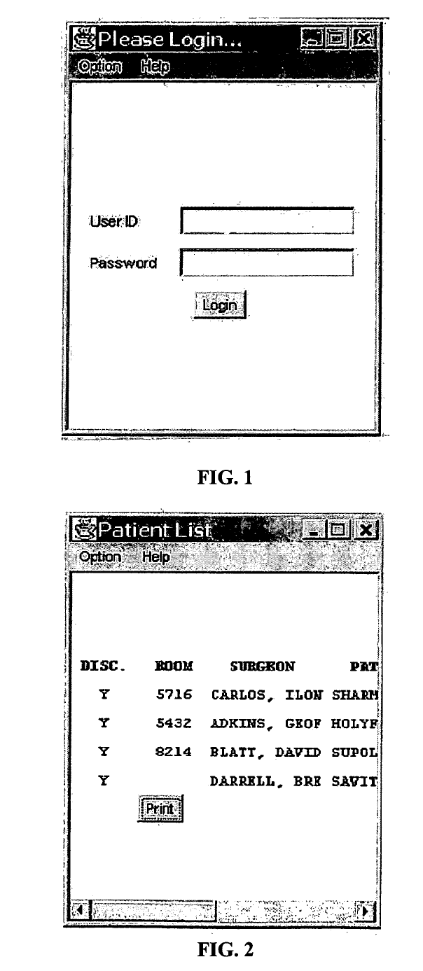

The first screen a user sees after logging into the Medforms application is the Patient List (FIG. 2). This list displays all patients previously denoted through the application as being “trauma active” currently in the hospital plus those patients that have been discharged in the last 24 hours. Patient data in this list comes from the hospital ADT data and is downloaded by the Medforms application when the hand held device is cradled.

The goal of this screen is to provide the user with a single location to view the primary patients of interest to the Trauma Center. This screen represents the same function scope as the hard copy patient list currently being used. The user can drill down into the patient detail screen by clicking on the specific patient name.

Notes:
In the Medforms application you may work on the one patient's billing record at a time. Once you begin working with a patient you may save or cancel the information before selecting a new patient.
Patients are determined by the Medforms application to be “trauma active” when at least one trauma form inside the Medforms application has been completed for that patient.
   Patient Search

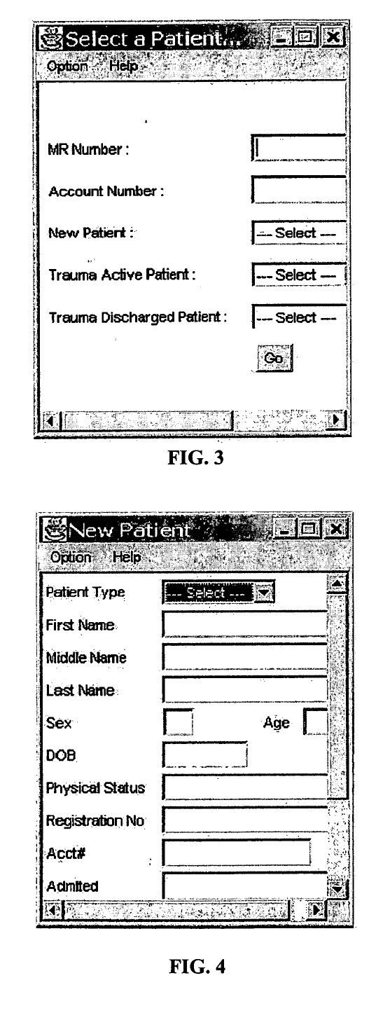

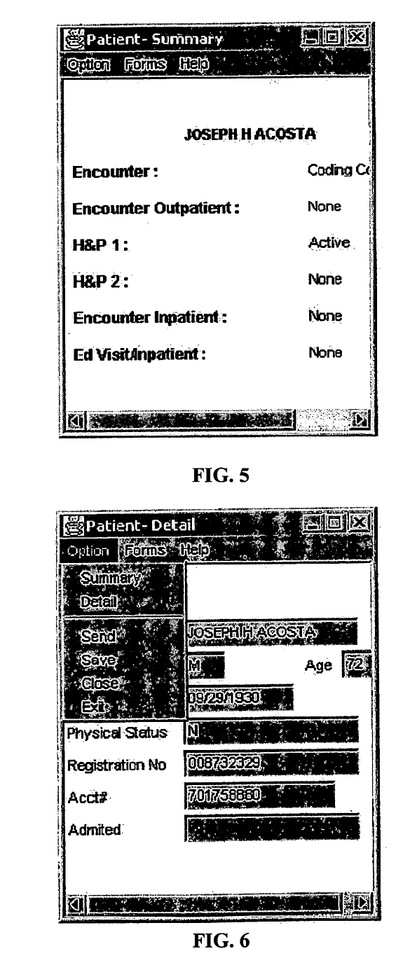

Patient Search screen (FIG. 3) provides the user the ability to search for specific patients against the complete list of patients, which have been admitted to the hospital. This search can be for both trauma active patients and those that have not yet been helped by the trauma center. The user has the ability to type in the specific record number or select the specific patient name in one of the search lists. After selecting the specific search criteria and clicking the ‘Go’ button, the user is directed to the Patient Detail screen, see FIG. 6.

Adding a New Patient

To add a new patient, tap on the ‘Option’ menu selection of the Patient Search screen and then tap on ‘New Patient’. The New Patient screen, see FIG. 4, will open. Enter all of the available information and tap the ‘Add” button. If the required information is not entered you will see a message indicating what is missing. Fill in the required information and tap the ‘Add’ button. You will be returned to the Patient Search screen. Any new patients will be appended to the end of the patient list in the order in which they were entered.

As part of adding a new patient, a patient type may be selected (TS=trauma surgery, CC=critical care, GS=general surgery, WC=wound care). The trauma activation form will only be available to the user for patients where the patient type has been selected as TS or CC.

Patient Detail and Patient Summary Screens

Once you have selected a patient, you will be sent to the Patient Detail screen, see FIG. 6, which is similar to the New Patient screen and contains the same information in a slightly different layout. The user will select the patient type TS or CC on the patient detail page to get access to a trauma activation form. If the user tries to go to the trauma activation form without completing the patient type, they will be prompted by the Medforms application to complete the patient type. From the patient detail page (FIG. 6) the user can navigate to the Patient Summary screen (FIG. 5) by tapping the ‘Option’ menu selection and then tapping ‘Summary’, as shown in FIG. 6. The Patient Summary screen contains information relating to each form for the currently selected patient. For each form listed in the Patient Summary screen (FIG. 5), you will see a status. The statuses are as follows:
None—No billing information has been entered
Active—Billing information has been entered but is not complete
Coding Completed—Coding is completed for the form and ready to be sent

These statuses are maintained by both the Medforms application and the user. Once you have entered any piece of information on a form for a patient, The form is automatically marked as ‘Active’ (see FIG. 5). If you then delete that information, the form's status is returned to ‘None’. The form is only marked Coding Completed by the user. To complete a form, simply select the ‘Coding Completed’ checkbox on the form's summary screen. If the minimum requirements have not been met, an error message displays indicating what is missing. Otherwise, the form's status will update to ‘Coding Completed’.

The menu selections are consistent across the Patient Detail and Patient Summary screens. From the ‘Option’ menu you may select from the following actions.

(See FIG. 6)

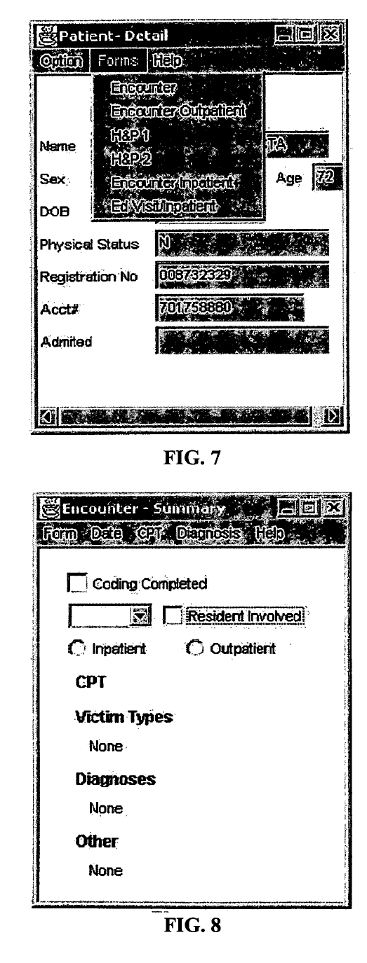

Send—prepares all “coding complete” patient's billing records for delivery to the Medforms server
Save—saves all of the currently selected patient's billing information to the PocketPC
Close—navigates the user back to the Patient Selection screen
Exit—exits the Medforms application
From the ‘Forms’ menu you may select from the list of available forms. See FIG. 7.
   Note:
On the Patient Summary screen you may alternatively tap the form name on the screen itself without needing to navigate to the ‘Forms’ menu.
   Working with Forms

There are seven forms included with your Medforms application. Each form includes a form level summary screen, which details the information, which has been entered for the currently selected patient for that form. Upon selecting a form to work with, the user is forwarded to that form's summary screen. See FIG. 8 for an example of the Summary screen for the Encounter form.

For the Summary screen (FIG. 8), the top menu options change to reflect valid actions for that particular form. However, the first menu option is always ‘Form’ and the available actions are consistent across all forms. As stated above, context sensitive help is also available for each form.

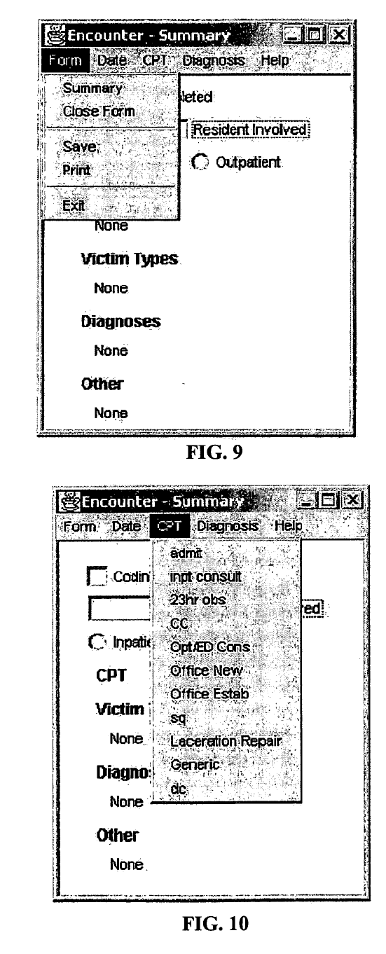

The following summarizes the form actions. (See FIG. 9)
Summary—navigate to the form's Summary screen
Close Form—close the current form and navigate to the Patient Summary screen
Save—saves all of the currently selected patient's billing information to the PocketPC
Print—opens the printer selection window and prints the current form
Exit—exits the application (it will prompt for the user to save if needed)

The following is more detailed user information for each of the forms available in the Medforms application.

Encounter, Encounter Outpatient, and Emergency Department (ED) Visit/Inpatient Forms

Each of these forms includes primarily Current Procedural Terminology (CPT®) coding, victim type and diagnosis information; this is reflected in the menu options available. The invention greatly simplifies the usual process of manually filling and further handling these forms. In part, this is done by presenting a sequence of easy to use, relatively short screens, which can be easily viewed in a PDA sized format. These screens may be used to input information primarily by selecting from menus or other lists of options presented therein. These selections provide all of the information needed for the corresponding form.

Referring to FIG. 10, to enter CPT® codes, tap on the ‘CPT®” menu item and select the CPT® by tapping on the appropriate item in the menu. Each of the CPT® screens is identical in format. See FIG. 11 for example. The first field on the screen is the Date field, which is used to record the date of service. By default the date field is populated with the date and time at which the user first selected the CPT® coding section. See the Date Selection section for more information.

In FIG. 11, a list of appropriate CPT® codes and relevant information is shown on the screen. For some screens, the list is long and wide and you may need to scroll down and across the page to see the entire list. Each code can be selected by tapping in the checkbox beside the CPT® code. Additionally a comment or further information can be entered or edited by tapping on the comment area. See the section below on Comments for further information.

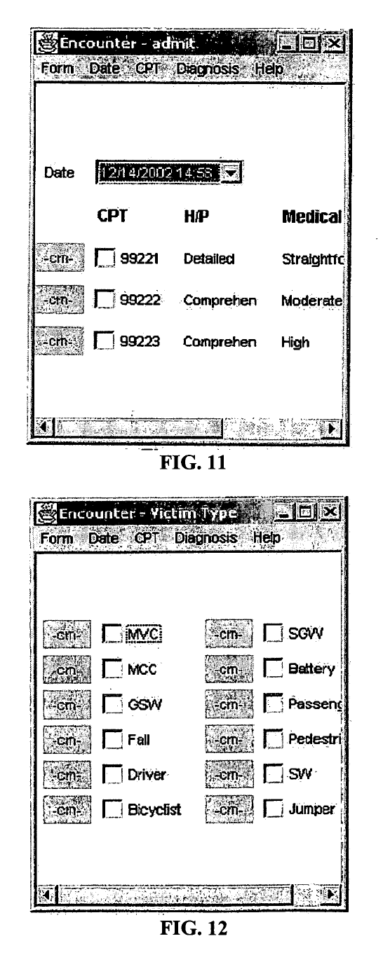

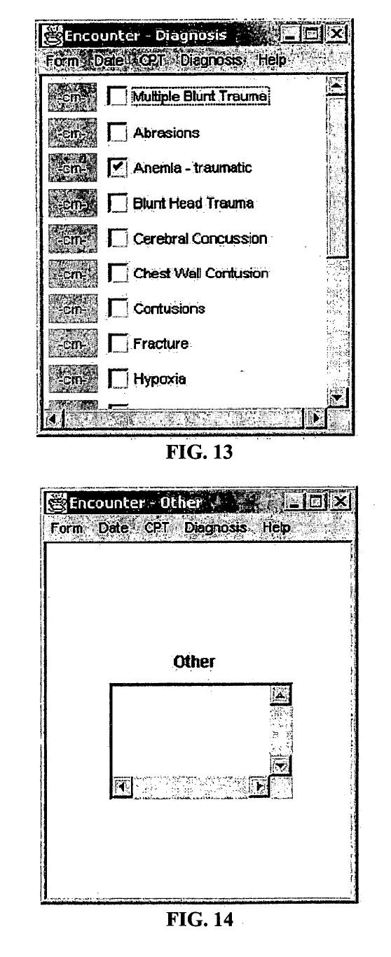

These forms also include Victim Types and Diagnosis sections. See FIGS. 12 and 13 for examples. They are accessed by tapping on the Diagnosis menu option. Both screens are similar to the CPT® Coding screens in that you can select the appropriate checkboxes and add comments. They are different in that they do not include a date selection. Finally, these forms include an Other section that may be used for general comments or information. It, too, is accessed by tapping on the Diagnosis menu option. See FIG. 14 for an example.

Health and Physical (H&P) 1 Form

The H&P 1 form includes several screens and images. On the History screen, see FIG. 15, you may enter as much information as is relevant in the fields provided. See FIG. 15. To populate the date/time fields for the doctor and nurse entries, you can use the Date selection screen, described below. There are also several screens with images for this form. See the Images section below for more information.

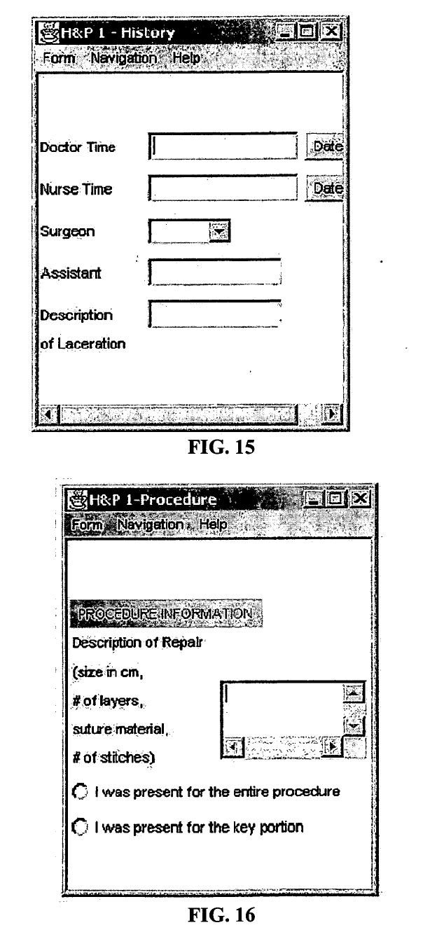

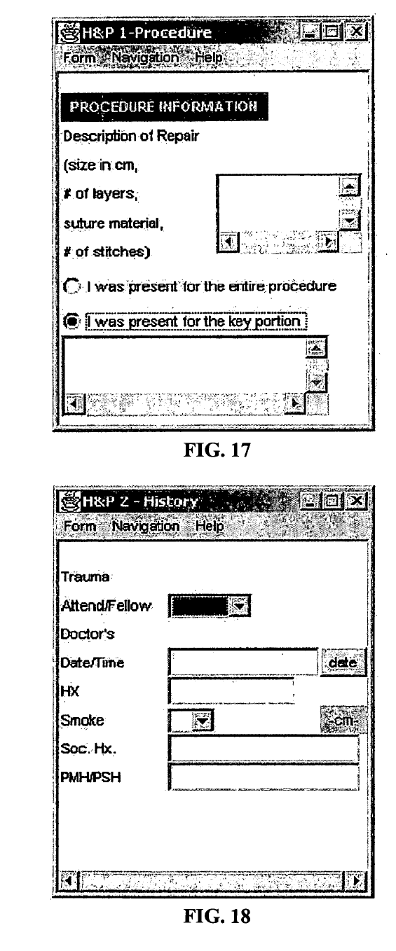

Referring to FIG. 16, a Procedure screen contains a selectable area similar to the Comment section (FIG. 14) on the Encounter form. For this form, the area is used for entering procedure information and is thusly labeled. Functionally, this section works identically to the Comment section. Also, the Procedure screen has a text area for the user to enter the Description of the Repair. The final section of the Procedure page, see FIG. 17, has two buttons to denote presence during the procedure. If one of these options is selected a text area appears where you may elaborate your answer.

H&P 2 Form

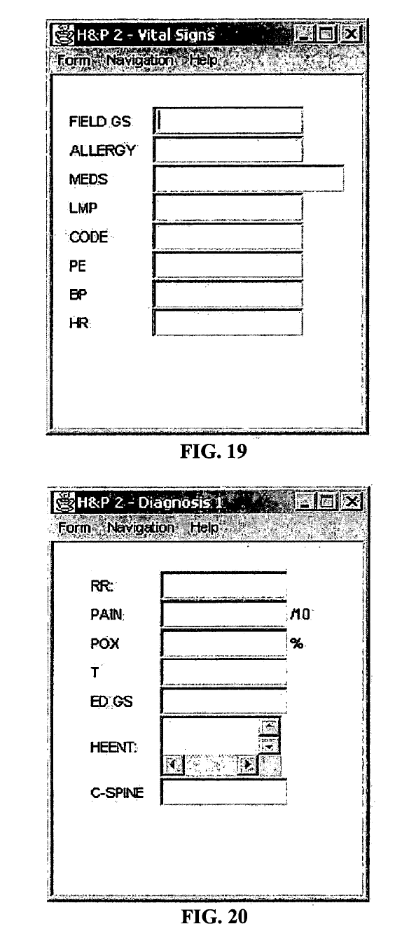

Referring to FIG. 18, this form is similar to H&P 1 (FIG. 15). It includes text and image screens. On the History screen, you may enter as much information as is relevant in the fields provided. To populate the date/time fields for the doctor entry, you can use the Date selection screen. See the Date Selection section below for more information. The other screens for this form are similar in functionality: Vital Signs, Diagnosis 1, Diagnosis 2, Diagnosis 3 and Lab Results. These screens are shown in FIGS. 19-23. Both H&P 1 and 2 contain image screens. A detailed discussion on the MedForms application image processing is included under the “Images” section below.

Encounter Inpatient Form

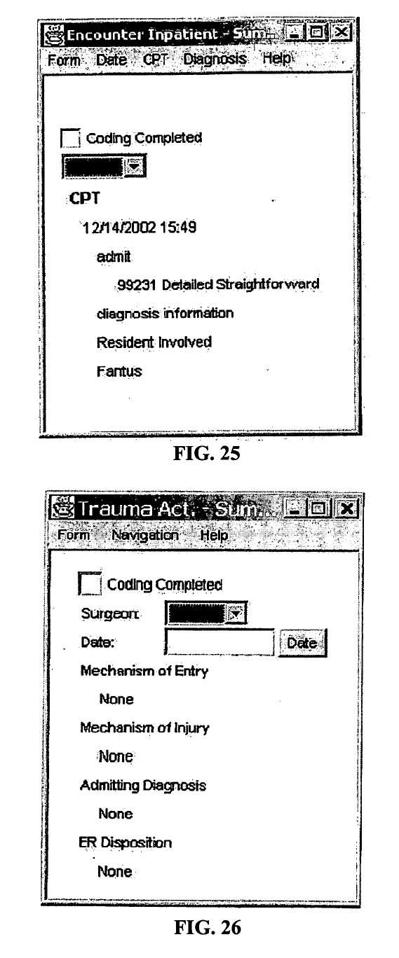

Referring to FIG. 24, this form is very similar to the other CPT® coding related forms (Encounter, Encounter Outpatient and Emergency Department Visit/Inpatient). It too has CPT® coding screens with a date selection. See above for more information. However, under the Diagnosis menu for this form there is only one option: Diagnosis. This screen is different from the Diagnosis screen for the other forms. For this form, the requirement is that the user enters one or more CPT® codes as well as diagnosis information for each date. This may best be demonstrated with a screen shot of the Summary screen for this form when it is correctly filled out. See FIG. 25. That Summary screen shows one CPT® (admit 99231) selected for Dec. 14, 2002 15:49 as well as the diagnosis information from FIG. 21 for that same date and time.

Trauma Activation Form

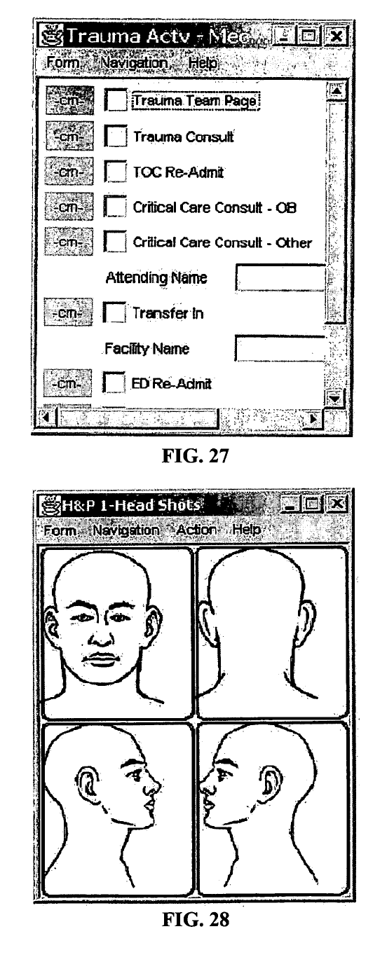

The trauma activation form includes the form summary screen and four detail screens. See FIGS. 26 and 27. Selecting the ‘Navigation’ option in the toolbar associated with this form accesses the detail screens. These detail screens cover the mechanism of entry, mechanism of injury, admitting diagnosis, and ER disposition.

Images

H&P 1 and 2 contain image screens in addition to the text screens. FIGS. 28-30 display the image screens inside the Medforms application. To draw on the image, simply use the stylus as you would a pen. Make sure that the PocketPC is not in transcriber mode or that transcriber mode is disabled while drawing. You may ‘erase’ all of the marks you have made to the image by selecting ‘Action’ and ‘Clear’ from the menu. To save the image with your markings for this patient, choose ‘Action’ and then ‘Save’ from the menu. If you attempt to navigate off of this screen by selecting another menu item, you will be prompted to save any changes you have made to the image. All saved files will automatically be synchronized with their respective completed forms upon cradling.

Comments

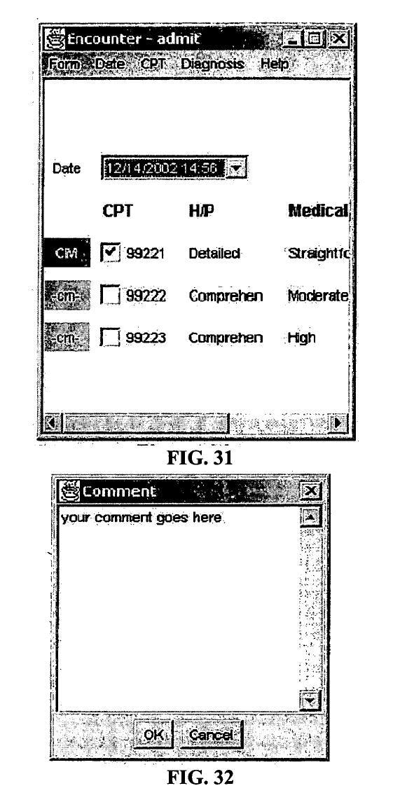

Referring to FIGS. 31 and 32 several of the screens in the Medforms application allow the user to enter comments or additional information. The comment windows/sections are denoted by ‘-cm-’ when no comment information is entered and the coloring is blue letters on a gray background. When comment information is entered, the section has bold ‘CM’ letters on a blue background. To enter comment information, tap on the comment section (either ‘-cm-’ or ‘CM’). The comment window, FIG. 32, will open. Write your comment in the box and tap ‘OK”.

Date Selection

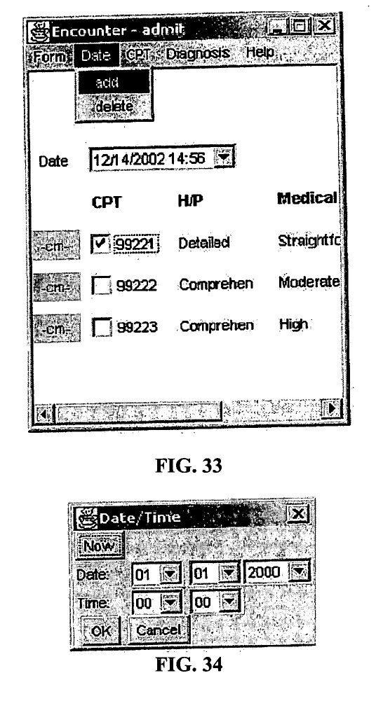

Several of the forms in the Medforms application which record CPT® coding information may be used over the course of two or more days and the billing record is not going to be completed and sent until the final day. The Medforms application gives the user the freedom to enter CPT® information in a time frame that is appropriate to the situation and does not restrict the user to one date per CPT® coding selection. For example, if the user needs to enter information in the Admit section both today and then again tomorrow, they may do so without need to complete a form today and then start a new form tomorrow. All the user needs to do is to enter the information today and save the information to the PocketPC. Tomorrow the user may select the same patient and open the same form and CPT® section. The previous day's information is displayed. Referring to FIG. 33, to enter the second day’ information, the user selects ‘Date’ and ‘Add” from the menu. The Date window (FIG. 34) will open.

To enter the date, the user may either tap the ‘Now’ button to default to the current date and time or the user may manually tap the screen on each of the dropdown lists to select the day, month, year, hour and minute. Note that even after tapping on ‘Now’, the user may change any of the fields before tapping on ‘OK’. Once the user taps ‘OK’, the Date/Time window closes and the date field on the screen, e.g., in FIG. 33, is populated with the selected date. To view information selected for any date in the date dropdown list, simply tap the screen on the date dropdown list and select the date of interest.

Saving Forms

To save forms, simply tap on ‘Form’ and then ‘Save’ at any point in time. The entire billing record for the patient will be saved to the PocketPC in its current state and will remain there until you complete the billing record and send it. The saved information is not synchronized to the Medform server and is available only on the PocketPC where it was saved. You may choose to save the billing information in an incomplete form to the PocketPC for many reasons such as the need to enter more information on a subsequent day. Saved patient information may be recalled by simply selecting the same patient from the Patient List or Search screens. All of the saved information is automatically available, including saved images.

Sending Forms

Choosing ‘Send’ from the Form menu indicates that you have completed the billing record for the patient and are ready to synchronize that information to the Medform server where it will be sent for billing. The Medforms application will allow you to send the billing record for a patient with the Encounter and H&P 2 forms with status ‘Coding Completed’ and the remaining forms with status ‘None’. You would not be allowed to send the billing record if the Emergency Department (ED) Visit/Inpatient form (FIGS. 11-14) has a status of ‘Active’.

Printing Forms

Print capability is available for the patient list and all forms except Trauma Activation. You may print forms from within the Medforms application. For the individual forms, you may print the form for a patient at any point in time, which will show information entered for that patient. If the form has not yet been marked as ‘Coding Complete’ then the printed form will have an ‘In Process” watermark across the page.

To print the patient list, simply tap the print pushbutton at the bottom of the Patient List screen (FIG. 2). To print forms, select a patient, select the form to print and then select ‘Print’ from the Form menu option. After selecting print for either the patient list or individual, you will see a screen with the selection of printers. You may select to print to either a network printer or the Infrared option. If you select a network printer 70 (FIG. 35), you may first cradle the device and then select the ‘Start’ option to begin the printing process. In order to print via the Infrared option, the PocketPC may be no more that a few feet from the printer. The device is held in that position until all data has been beamed from the device to the printer. This process normally takes approximately fifteen seconds.

Synchronizing Billing Records

To synchronize between the PocketPC 40 and Medforms server 60 as to the billing records which have been marked as completed and sent, all the user needs to do is to close the Medforms application and cradle the PocketPC. The synchronization process occurs automatically and will upload all appropriate patient records to the Medforms server, deleting them from the PocketPC. Any billing records which had been saved but not been marked as coding complete will remain on the PocketPC for further use. See the Synchronizing Patient ADT data section above for further information.

User Id and Password Maintenance

Medforms provides simple user ids and passwords maintenance. This maintenance is intended for the Medforms application system administrator and can only be accessed directly through the Medforms Server. See FIG. 35 and 36. No end-user access to perform user id and password maintenance is available through the PocketPC.

Other Features/User Interface

Users/Security

Each physician/provider will have his/her own iPAQ or other compatible PocketPC. This will allow the providers to keep their personal email, schedule, contacts, etc. on the iPAQ. This also means we only have to turn on user id/password at the iPAQ level not the application level. However, inside the application the user can select which doctor should be associated with each patient or form. Also, the physician providing the service is to be identified on the form at the service level.

Forms/Records

Signatures are not required on the Medforms-created input information/documents. All forms are considered independent of each other, but under the same patient. However, more than one form can be used for the same patient. New Patient Admission records may be entered into the Medform application. However, this will not be the same amount of data that is currently being held in the iPAQ for patient records coming from the hospital systems. It will only be a sub-set of the summary patient record information.

The ID number for such new patients may have to be a sequential number or a number that the patient is assigned in the Trauma Department. For such new records, the entered information includes name, date of birth, social security number, etc. Reconciliation between the new number entered or generated by the Medforms application and the ADT Health Level 7 (HL7) download from the hospital is not required. However, if a Patient ID number generated by the hospital ADT data is used (e.g. with an incomplete patient record) to establish a patient record then the data downloaded from the server should update this record. Patient summary information cannot be updated on the iPAQ since this would cause an out-of-sync situation with the hospital systems. In this regard, ADT Patient data downloaded to the iPAQ from the server is for display only. However, the physician will be allowed to update certain data that becomes available while they are treating the patient. Information need not flow back to the hospital system.

Some CPT® descriptions may be shortened to fit on the iPAQ screen.

Operation

The Medforms server extracts new Trauma Center patients coming from hospital systems, populates these new patients into SQL Server DB and pushes patient Extensible Markup Language (XML) files onto all assigned local PCs. The PocketPC is updated with this patient XML files when the PocketPC is cradled and synchronized with a local PC.

Trauma Center Physicians log into Medforms application and select the patient. Under the specific patient the physician pulls up the specific form and enters details (Java-based forms). At any time the physician can save the patient forms to the PocketPC. When the physician denotes form as complete and the PocketPC is cradled, the form is synchronized back to the local PC (XML file) and onto the Medforms server.

Print forms are created by going into specific form under the patient and selecting “print.” Physicians can send print forms to printer via infrared communication or through local network (when PocketPC is cradled with the local PC). Print forms will display whether the form has been completed or not. Completed patient forms are pulled from the Medforms server and forwarded to the biller, hospital records, government agencies and others electronically.

ADT HL7 data from the hospital's server to the iPAQ may be used to populate certain fields in the forms and the completed forms transmitted to the biller as XML documents. The applicable fields (information and data) on the forms are expected to be populated from the HL7 data or by the physician filling in the data. This completed data is to be transmitted to the biller. Moreover, if the completed forms are to be transmitted as XML documents selecting the same CPT®-IV code from different forms should not cause any duplicate record problems. Even if this data was mapped as HL7 segments, each service will have a separate segment (record) and will not be a duplicate record. Incomplete forms remain on the specific PocketPC until completed. (However, physicians can still create any form for any patient regardless of activity on another PocketPC.)

### Medforms Application Systems Architecture

1. File Structure

1.1 Database Files/Master Files

Includes Admissions, Discharges and Transfers (ADT) data segments such as Message Header (MSH), Patient Visit (PV1), Next of Kin (NK1), etc
CPT®-IV procedures file
ICD-9-CM diagnoses file
Attending Physician
Translation files/tables—patient physical status, place of service, type of service, relationship, etc
Work files—temporary storage, batch totals, print spool,

1.1 Output files
Patient/Guarantor ADT data
Billing data
Reports
   2. Application Programs

1.1 Entry Programs
Program name, description, files used, source listing, etc.

1.1 Display Programs
Forms # 1—pop up windows, on-line edit programs, exit processing and minimize/hide/overlay displays

1.1 Processing Programs
Data entry, creating billing records, broadcasting patient data and updating database
   Hardware Components and Software Components

Below are noted the hardware and software components used for the Medforms application. Some of the components noted are part of the hospital's existing systems infrastructure.
Allegra server (Hospital's Patient Information System)
E-Gate server (Hospital's Patient Information System)
Medforms server (located in hospital domain)
   Windows2000 Server
   Java 1.1.8
   Microsoft SQL Server Database
   Compubill_datafeed.jar
   Norton AntiVirus
   Synchrologic Sync Software
The biller's server
ER/Trauma Center workstations
   Windows2000 Professional
   Synchrologic Sync and Microsoft ActiveSync
Compaq iPAQ PDA with cradle
   WindowsCE
   Compubill.jar
   Field Software PrinterCE
   CrEme Java Virtual Machine
   Synchrologic Sync and Microsoft ActiveSync
      File Definitions
      Patient Data File

This file contains the ER and Trauma ADT Patient demographic data in the ADT HL7 format to be parsed into XML for the Medforms application.

Patient Demographic XML File

This XML file contains the ER and Trauma ADT Patient demographic data required for the Medforms application.

Reference XML File

This file contains the data used to construct the CPT® and ICD-9 information in the forms displayed in the Medforms application.

Patient Status File

This file is generated by the Medforms application and is used by the process running on the Medforms server to help determine which Patient records to extract from the patient info database for use by Medforms.

Billing XML Files

Each of these files contains all of the data entered for a patient in the Medforms application.

Image Files

These files contain images that correspond to the head and body images, which were saved for a patient in Medforms. Each of these files corresponds to a Billing XML file and is part of the patient billing record.

Data Flow

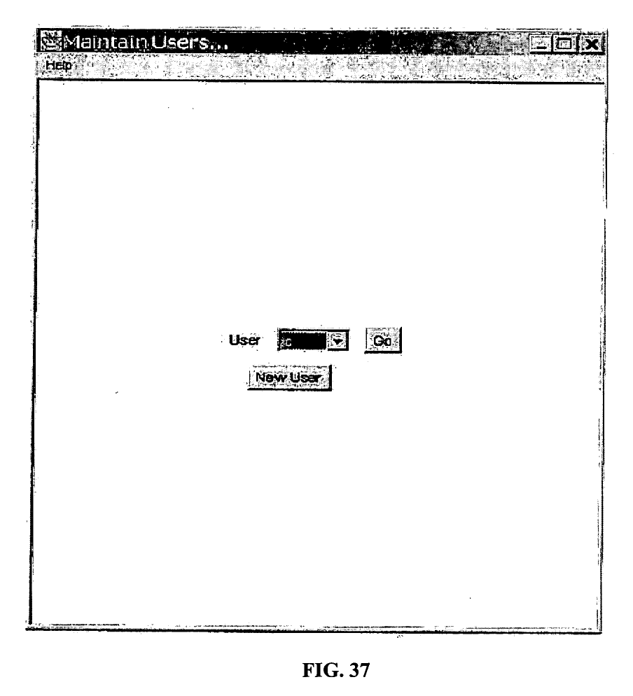

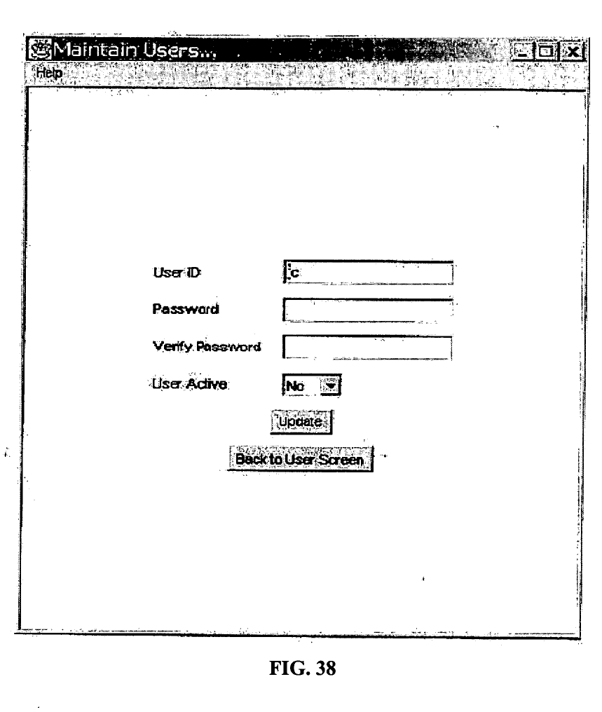

FIGS. 37 and 38 show graphical representations of the system architecture and data flow.

ADT Patient (HL7) Data

Hospital's Patient Information server sends ER and Trauma ADT Patient demographic data to the e-Gate server.—Gate server File Transfer Protocols (FTP's) the ER and Trauma ADT Patient data down to the Medforms server. A scheduled task runs on the Medforns server to process ADT Patient data upon download. The Medforms server backs up the HL7 data file in archive directory with date/time stamp.

Parsing ADT Patient (HL7) Data File on Medforms Server

A java program runs on the Medforms server to first parse the ADT Patient data and to then insert the records into the patient info database. A java program queries the patient info database to create the Patient demographic XML file for use by the Medforms application. The format of the Patient demographic XML is validated and the file is saved to the download directory. The Patient demographic XML file is backed up with a date/time stamp and stored on the Medforms server.

File Upload/Download Process (Synchronization)

Upon cradling the iPAQ, the Patient demographic XML file and the reference XML file are downloaded from the Medforms server's download directory to the iPAQ. The patient status file and all billing XML files with the corresponding image files are uploaded to the Medforms server's upload directory.

Transmitting Billing XML Files and Image Files to Billing Server

Medforms Application

Once the Medforms application and supporting software have been installed on the iPAQ, the device may be cradled at any ER/Trauma Center workstation, which is connected to the Medforms server. Upon cradling, the appropriate files are transferred between the iPAQ and the Medforms Server automatically without user intervention.

Once the transfer is complete, the user may start the Medforms application on the iPAQ. The application may be run whether or not the device is cradled. The only times the device may be cradled is either when the user wants to synchronize the files or when the user wants to print from Medforms to a remote networked printer or to a networked printer that does not support infrared printing.

Microsoft ActiveSync is the basic software component necessary to synchronize files and other information between an iPAQ and the PC to which it is cradled via “partnerships”. The current implementation of ActiveSync restricts each iPAQ to two partnerships, meaning that it can be cradled at up to two different PCs and synchronized. The Medforms application supports cradle the iPAQ at any one of a number of workstations, meaning more than two partnerships are supported. Synchrologic software on top of Microsoft ActiveSync gives us the freedom to cradle at many locations and synchronize our files to a central server. Both components are necessary to complete the synchronization process.

Printing Medforms Forms

As indicated above, user may print forms from within the Medforms application. To do so, the user selects the form to print and then selects ‘Print’ from the Form menu option. The user will see a splash screen from the PrinterCE software and is given the selection of printers. The user may select either a network printer or the Infrared option. If a network printer is selected, the user may first cradle the device and then start the printing process. In order for the infrared printing to work, the device may be in a direct line of sight to the printer and may be no more than four feet from the printer. The device may be held in that position until all data has been beamed from the device to the printer. This process normally takes approximately fifteen seconds.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A system for managing medical records and billing data comprising:
means for storing one or more medical forms;
means for converting each of said forms to a sequence of simplified screen displays;
means for downloading said sequence of simplified screen displays in a form legibly displayable on a handheld device;
means for entering information into each of said displays as selections from one or more display menus comprising a part of said screen displays.

2. A system according to claim 1, wherein at least some of said menus comprise drop-down displays on a computer screen.

3. A system according to claim 1 wherein said means for converting comprises means for converting said forms to a sequence of simplified screen displays which are sequentially displayable on a handheld device screen.

4. A system according to claim 1 wherein at least some of said screen displays include space for entering user-generated information.

5. A system according to claim 1 and further including means for uploading information entered via said screens to another computer.

6. A system according to claim 1 and further including means for converting data from said screen displays to standard ADT HL-7 record segments used for storing patient records.

7. A system according to claim 1 and further including means for saving said information prior to uploading information entered via said screens to another computer.

8. A system according to claim 1 and further including means for saving said information and means for modifying said information prior to uploading information entered via said screens to another computer.

9. A system according to claim 6 wherein said means for saving includes means for adding to said information entered via said screens prior to uploading information entered via said screens to another computer.

10. A system according to claim 1 and further including means for delivering information entered via said screens to a printer.

11. A system according to claim 1 wherein said means for storing, and said means for converting comprise a software application hosted on a server.

12. A system according to claim 1 wherein said means for entering comprises a handheld device.

13. A method for managing medical records and billing data comprising:
storing one or more medical forms;
converting each of said forms to a sequence of simplified screen displays in a form legibly displayable on a handheld device;
downloading said sequence of screen displays to a computer;
entering information into each of said screen displays as a sequence of selections from one or more display menus comprising a portion of said screen displays.

14. A method according to claim 13, wherein at least some of said menus comprise drop-down displays on a computer screen.

15. A method according to claim 13 wherein said converting comprises converting said forms to a sequence of simplified screen displays which are displayable on a handheld device screen.

16. A method according to claim 13 wherein at least some of said screen displays include space for their entering user-generated information.

17. A method according to claim 13 and further including uploading information entered via said screens to another computer.

18. A method according to claim 13 and further including converting data from said screen displays to standard ADT HL-7 record segments used for storing patient records.

19. A method according to claim 13 and further including delivering information entered via said screens to a printer.

20. A method according to claim 13 wherein said storing, and said converting include providing a software application hosted on a server.

21. A method according to claim 13 wherein said entering comprises entering on a handheld device.

22. A method according to claim 17 wherein said uploading comprises uploading selected portions of said entered information.

23. A method according to claim 21 wherein said selected portions comprise portions of said entered information utilized for billing purposes.

24. A system for managing medical records and billing data comprising:
a server for storing one or more medical forms, for converting each of said forms to a sequence of simplified screen displays in a form legibly displayable on a handheld device and for downloading said sequence of simplified screen displays to a user's computer;
a user's computer for entering information into each of said displays as selections from one or more display menus comprising a part of said screen displays and for uploading information entered via said screens to the server, and
a selectively usable data transfer facility between said server and said user's computer for facilitating said downloading and said uploading.

25. A system according to claim 24, wherein at least some of said menus comprise drop-down displays on a computer screen.

26. A system according to claim 24 wherein said server hosts a software application for converting said forms to a sequence of simplified screen displays which are displayable on a handheld device screen.

27. A system according to claim 24 wherein at least some of said screen displays include space for their entering user-generated information.

28. A system according to claim 24 said user's computer further delivering information entered via said screens to a printer.

29. A system according to claim 24 wherein said hosts a software application for storing one or more medical forms, for converting each of said forms to a sequence of simplified screen displays and for downloading said sequence of simplified screen displays to a user's computer 30. A system according to claim 24 wherein said user's computer comprises a handheld device.
